(19) United States
(12) Patent Application Publication
(10) Pub. No.: US 2005/0011464 A1
(43) Pub. Date: Jan. 20, 2005

(54) Additive composition for feeding aquaculture animals and feed containing the same

(75) Inventors: Hau Yin Chung, Hong Kong (CN); Put O. Ang JR., Hong Kong (CN); Ying Shiu Norman Woo, Hong Kong (CN); Wing Chi Joyce Ma, Hong Kong (CN)

Correspondence Address: MCANDREWS HELD & MALLOY, LTD, 500 WEST MADISON STREET, SUITE 3400, CHICAGO, IL, 60661, US

(73) Assignee: The Chinese University of Hong Kong

(21) Appl. No.: 10/890,695

(22) Filed: Jul. 14, 2004

Related U.S. Application Data
(60) Provisional application No. 60/486,944, filed on Jul. 14, 2003.

(51) Int. Cl. A01K 61/00

(52) U.S. Cl. 119/230

(57) ABSTRACT

Disclosed is an additive composition of a feed for breeding an organism comprising at least one genus of marine algae containing an effective amount of one or more compounds selected from the group consisting of unsubstituted bromophenol and bromophenols substituted with one or more substituents. Also disclosed are a feed containing the additive composition and a method for preparing the feed. Application of the feed disclosed herein to aquaculture animals can greatly enhance the organoleptic quality thereof.

### RELATED APPLICATIONS

The present application claims the benefit of U.S. provisional application Ser. No. 60/486,944 filed on Jul. 14, 2003, entitled the same, which is explicitly incorporated herein by reference in its entirety.

### FIELD OF THE INVENTION

The present invention is directed to an additive composition for feeding an organism and a feed containing the same, particularly to an additive composition coming from marine algae that may enhance the organoleptic quality in aquaculture animal.

### BACKGROUND OF THE INVENTION

U.S. Pat. No. 6,391,331 is concerned with the application of seaweed supplement to cattle and swine to enhance quality other than flavor one. But, it doesn't deal with marine animals.

U.S. Pat. No. 5,350,588 discloses a feed that requires an extraction step operated at warm temperature. The dried and grinded product is mixed at suitable proportion to the original feed, and subjected to drying process. The requirement of at least one type of bromophenols is necessary for the enhancement of the flavor in the current invention.

The flavor of seafood, composed of both volatile and nonvolatile components, is closely related to the perception of the consumers (Lindsay, R. C., Food Rev. Int., 1990, 6, 437-455; Josephson, D. B., Seafood, In Volatile Compounds in Foods and Beverages; Maarse, H. Ed.; Marcel Dekker: New York, N.Y., 1991, pp 179-202; Shahidi, F.; Cadwallader, K. R. Flavor and lipid chemistry of seafoods: an overview. In Flavor and Lipid Chemistry of Seafoods; ACS Symposium Serious 674; Shahidi, F.; Cadwallader, K. R. Eds.; American Chemical Society: Washington, D.C., 1997; pp 1-8). The nonvolatile taste-active constituents include nucleotides and free amino acids, and the volatile compounds include lipid-derived compounds such as alcohols, aldehydes, ketones, sulfur- and nitrogen-containing compounds, etc. (Josephson, D. B., Seafood, In Volatile Compounds in Foods and Beverages; Maarse, H. Ed.; Marcel Dekker: New York, N.Y., 1991; pp 179-202. Chung, H. Y. J. Agric. Food Chem. 1999, 47, 2280-2287; Chung, H. Y.; Yung, I. K. S.; Ma, W. C. J.; Kim, J. S. Food Res. Int. 2002, 35, 43-53).

Compounds that are responsible for the sea- or brine-like aroma are related to a group of bromophenol homologues including 2-bromophenol, 4-bromophenol, 2,4-dibromophenol, 2,6-dibromophenol and 2,4,6-tribromophenol (Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol. 1992b, 1, 43-63; Whitfield, F. B.; Helidoniotis, F.; Shaw, K. J.; Svoronos, D. J. Agric. Food Chem. 1998, 46, 3750-3757). They are commonly detected in different species of seafood, including marine fish, crustaceans, mollusks, etc. in different locations around the world, but are absent in the fresh water animals (Boyle, J. L.; Lindsay, R. C.; Stuiber, D. A. J. Food Sci. 1992a, 57, 918-922; Whitfield, F. B.; Helidoniotis, F.; Shaw, K. J.; Svoronos, D. J. Agric. Food Chem. 1997, 45, 4398-4405; Whitfield, F. B.; Helidoniotis, F.; Shaw, K. J.; Svoronos, D. J. Agric. Food Chem. 1998, 46, 3750-3757; Ma, W. C. J. Evaluation of bromophenols in Hong Kong seafood and enhancement of bromophenol contents in an aquacultured fish (Sparus sarba) (Thesis); The Chinese University of Hong Kong, HKSAR, China, 2002). They are produced by marine algae and polychaetes, and distributed throughout the food chain (Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol. 1992b, 1, 43-63; Whitfield, F. B.; Shaw, K. J.; Walker, D. I. Water Sci. Technol. 1992, 25, 131-139).

Wild marine animals obtain their bromophenols from their diets and accumulate at each level along the food chain. The differences between the bromophenol contents in the wild-harvested and the aquacultured seafood are due to the differences in their diet contents. Several methods would be possible to increase the bromophenol content in the latter. Among them, direct addition of bromophenol chemicals to the cultivation water was found to be impractical and not environmentally friendly. Alternatively, incorporation of pure chemical bromophenols to the animal feeds had failed as majority of the chemicals were lost in the feed production process. A method to incorporate the animal feed with natural sources of bromophenols is a more practical choice because bromophenols appear to be more securely bound to their original cell structure (Whitfield, F. B.; Helidoniotis, F.; Shaw, K. J.; Svoronos, D. J. Agric. Food Chem. 1997, 45, 4398-4405). Marine algae containing specific enzyme system are capable of producing bromophenols high in concentration which is affected by the seasons (Whitfield, F. B.; Helidoniotis, F.; Shaw, K. J.; Svoronos, D. J. Agric. Food Chem. 1999, 47, 2367-2373; Ma, W. C. J. Evaluation of bromophenols in Hong Kong seafood and enhancement of bromophenol contents in an aquacultured fish (Sparus sarba) (Thesis); The Chinese University of Hong Kong, HKSAR, China, 2002). In fact, the marine algae are ideal choice as a natural dietary supplement of bromophenols and other dietary sources of protein and lipid for aquacultured animals (Wahbeh, M. I. Aquaculture 1997, 159, 101-109).

### BRIEF SUMMARY OF THE INVENTION

Accordingly, an object of the invention is to provide an additive composition of a breed for breeding an organism, which comprises at least one genus of marine algae containing an effective amount of one or more compounds selected from the group consisting of unsubstituted bromophenol and bromophenols substituted with one or more substituents. The substituent can be a halo, bromo, hydroxyl, lower alkyl, lower alkoxyl, or carboxyl group.

Another object of the invention is to provide a feed for an organism, which comprises an effective amount of an additive composition including at least one genus of marine algae containing one or more compounds selected from the group consisting of unsubstituted bromophenol and bromophenols substituted with one or more substituents, and a conventional feed.

A further object of the invention relates to a method for preparing the feed described herein, which comprises the steps of:
a) drying at least one genus of marine algae; and
b) mixing an amount of dried marine algae with a conventional feed.

Still another object of the invention is directed to a method for enhancing the organoleptic quality in aquaculture animal comprising feeding the animal a feed disclosed herein.

The invention enhances the flavor quality of the carcass of aquacultured animals. The technology of the invention can be widely used in the aquaculture industry to improve their product quality and hence increase their market value.

### BRIEF DESCRIPTION OF SEVERAL VIEWS OF THE DRAWINGS

FIG. 1 shows mean total bromophenol contents in the flesh of silver seabream with different fish feeds.

### DETAILED DESCRIPTION OF THE INVENTION

The active composition of a breed according to the present invention which incorporates with the dried marine algae containing 2-bromophenol and/or a 2-bromophenol derivative; 4-bromophenol and/or a 4-bromophenol derivative; 2,4-dibromophenol and/or a 2,4-dibromophenol derivative; 2,6-dibromophenol and/or a 2,6-dibromophenol derivative; 2,4,6-tribromphenol and/or a 2,4,6-tribromophenol derivative used in the present invention as an active ingredient is very useful as a feed for improving the organoleptic property of a marine animal such as a feed effective in enhancing the flavor quality.

The marine algae can be from any of the various algal classifications, preferably those that have been utilized in agriculture. Genus groups referred to in the invention include (red algae) Amphiroa, Callophycus, Cheilosporum, Chondria, Corallina, Delisea, Galaxaura, Gracilaria, Haliptilon, Halymenia, Lomentaria, Plocamium, Porphyra, Pterocladiella, Solieri; (brown algae) Cladostephus, Colpomenia, Cystophora, Ecklonia, Endarachne, Halopteris, Homoestrichus, Hormosira, Lobophora, Padina, Phyllospora, Sargassum, Sporochnus; (green algae) Caulerpa, Chlorodesmis, Cladophoropsis, Codium, Enteromorpha, Halimeda and Ulva (Chung, H. Y.; Ma, W. C. J.; Put, O. A. Jr.; Kim, J.-S.; Chen, F. J. Agric. Food Chem. 2003, 51, 2619-2624; Whitfield, F. B.; Helidoniotis, F.; Shaw, K. J.; Svoronos, D. J. Agric. Food Chem. 1999, 47, 2367-2373). The marine alga herein is preferably from the genus Sargassum and more preferably from Sargassum siliquastrum.

Dried marine algae which are used in the invention can be obtained by dehydrating marine algae used, for example, by freeze-drying and grinding the dehydrated material into a powder. The algal powder is then mixed with a conventional dry feed in powder to form a feed of the invention in a desirable proportion. In one embodiment, 30% of the total amount of the feed and water are provided to form a soft dough for shaping into a suitable form using a suitable equipment, such as an extruder. The feed of the present invention is then obtained by dehydrating the wet feed, for example, by freeze-drying.

Flavor quality of the marine animals is evaluated using the Triangle test of the discrimination test. Subjects are trained before actual products evaluation on the control and the experimental samples. Subjects are asked to pick out one sample which is different from the other two samples. Settings of the evaluation facility are set according to Meilgaard, M.; Civille, G. V.; Carr, B. T. Sensory Evaluation Techniques, 2nd ed; CRC Press, Inc.: Boca Baton, 1991. Replicated tests are carried out by each subject. Results are statistically evaluated at p=0.05 level of significance based on published table (Roessler, E. B.; Pangbom, R. M.; Sidel, J. L.; Stone, H. Food Sci. 1978, 43, 940-947).

The bromophenol compounds produced from marine algae are as metabolites in them. The feed of the present invention includes 2-bromophenol and/or 4-bromophenol and/or 2,4-dibromophenol and/or 2,6-dibromophenol and/or 2,4,6-tribromophenol and/or their derivatives. Such a feed is very effective to enhance the flavor quality of the marine animals.

As the concentration of each bromophenol in the marine algae may vary at the time of collection, all collected, dried and grinded marine algae are prefereably mixed first before incorporated into a conventional dry feed.

In one embodiment of the present invention, the feed includes a 30% Sargassum silliquastrum feed, with average concentrations of 2-bromphenol, 4-bromophenol, 2,4-dibromophenol, 2,6-dibromophenol and 2,4,6-tribromophenol at 3.87, 3.49, 67.2, 6.88 and 157 ng/g dry weight, respectively.

Conventional dry feeds include those produced using raw materials derived from animal such as fish meal, casein and squid meal; plant such as dextrin, soybean cake, wheat flour, starch and feed yeast; animal oil such as lard, cod-liver oil, squid-liver oil; and plant oil such as soybean oil and rape-seed oil, which may further include vitamins, minerals, amino acids antioxidants, and binder and the like. An example of the conventional dry feeds is composed of white fishmeal, dextrin, vegetable oil, lard, vitamin mix, mineral mix and carboxymethyl cellulose in the weight percentage of 82.66, 1.54, 6, 2.5, 2, 3.8 and 1.5, respectively (Woo, N. Y. S; Kelly, S. P. Aquaculture 1995, 135, 229-238).

The active composition of a feed of the present invention for breeding an organism containing at least one species of marine algae which contains at least one compound selected from the group consisting of 2-bromophenol and/or 4-bromophenol and/or 2,4-dibromophenol and/or 2,6-dibromophenol and/or 2,4,6-tribromophenol and/or a derivative thereof and the feed of the present invention containing the active composition as an active ingredient may be produced according to conventional methods in this field.

The content of the active composition of the present invention in the feed for the organism of interest is not limited to a specific one and may be determined depending on animals to be fed.

The method of preparing the feed of the present invention is performed by conventional technique in this field. One embodiment of the invention includes adding at least one dried marine alga which contains at least one bromophenol and/or its derivatives to a convetional feed.

The dry feed of the present invention is directly fed to the marine animals during the finishing period which is at least 30 days before transportation to slaughter.

The minimal amounts (equivalent to the flavor threshold value) of each bromophenol in the whitefish flesh/muscle to produce a recognizable sensation, are 10, 20, 50, 0.1 and 10 ng/g in fresh/wet sample for 2-bromphenol, 4-bromophenol, 2,4-dibromophenol, 2,6-dibromophenol and 2,4,6-tribromophenol, respectively (Boyle, J. L.; Lindsay, R. C.; Stuiber, D. A. J. Food Sci. 1992a, 57, 918-922; Boyle, J. L.; Lindsay, R. C.; Stuiber, D. A. J. Aquat. Food Prod. Technol., 1992b, 1, 43-63). Other marine animals will have similar flavor enhancement when the concentration of one or more bromophenols are equal to or above the minimal flavor threshold value.

Organisms to which the present invention can be applied include, but not limited to, cultured animals such as fishes (e.g. parrot fishes, flatfishes, yellowtails, young yellowtails, yellow jacks, salmon, trouts), crustaceans (e.g. glass shrimp, black tiger shrimps, blue crabs, red crabs) and shellfishes (e.g. scallops and oysters). The present invention can be widely applied to aquatic animals.

Interperitoneal and oral administrations of 2-bromophenol, 2,4-debromophenol and 2,4,6-tribromopehnol produce no sub-lethal toxic effects in mice (Sweet, D. V. Registry of Toxic Effects of Chemical Substances, Vol. 4; U.S. Government Printing Office: Washington, D.C., 1987). Comparing the LD₅₀ value of 2,4,6-tribromophenol administrated orally in rat and the concentration value in seafood on the same basis, the lethal dose is 200 to 500 times higher than the highest concentrations detected in the Australian crustaceans (Whitfield, F. B.; Last, J. H.; Shaw, K. J.; Tindale, C. R. J. Sci. Food Agric. 1988, 24, 29-42; Boyle, J. L.; Lindsay, R. C.; Stuiber, D. A. J. Aquat. Food Prod. Technol., 1993, 2, 75-112). With small amount of bromophenols found in seafood, the harmful effect is not critical to health.

Flavor quality in an organism of interest such as a laboratory animal, a fish, a crustacean, a shellfish can be enhanced with the product of the invention. Such enhancement can be accomplished by feeding the organism a feed containing at least one type of marine alga consisting of 2-bromophenol and/or 4-bromophenol and/or 2,4-bromophenol and/or 2,6-dibromophenol and/or 2,4,6-tribromophenol and/or their derivatives.

Cultured animals have the problem of culturing with a feed that contains low quantity of alga which contains the bromophenols and/or their derivatives. The new bromophenol- and/or derivative-containing algae dry feed of the present invention can greatly improve the flavor quality in the cultured animals bred in an aquaculture farm.

The present invention provides a feed for an aquatic animal composing of at least one type of marine alga which consisting of 2-bromophenol and/or 4-bromophenol and/or 2,4-bromophenol and/or 2,6-dibromophenol and/or 2,4,6-tribromophenol and/or derivatives thereof and a conventional dry feed. The feed is very useful as a flavor-enhancing feed.

The present invention provides a method for breeding an aquatic animal, characterized in that the method comprises feeding the animal at least one type of marine alga which containing 2-bromophenol and/or 4-bromophenol and/or 2,4-bromophenol and/or 2,6-dibromophenol and/or 2,4,6-tribromophenol and/or derivatives thereof and a conventional feed.

### EXAMPLE 1

A traditional feed was prepared from white fishmeal, dextrin, vegetable oil, lard, vitamin mix, mineral mix, carboxymethyl cellulose with weight percentage of 82.66, 1.54, 6, 2.5, 2, 3.8 and 1.5, respectively, with a method by Woo, N. Y. S; Kelly, S. P. Aquaculture 1995, 135, 229-238. The prepared dough was extruded using an extruder to produce wet pellets which were freeze-dried and stored at refrigeration temperature of 4° C.

A modified feed of the invention was prepared by the incorporation of 30% (w/w) freeze-dried algae in powder form, Sargassum siliquastrum, into the traditional feed. Acclimatized silver seabreams (100 g each) cultivated in indoor 1-tonne tanks with a closed seawater circulating system were divided into two groups for comparison for their bromophenols contents every two weeks after they were fed with tradition and modified feeds. Fishes were fed daily and the amount was 2-3% of the body weight of fish.

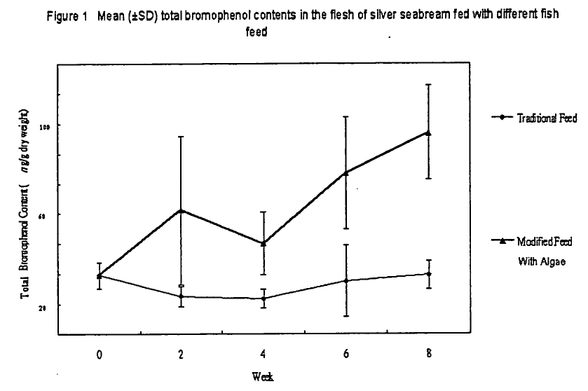

Total bromophenol contents are the sum of the concentration of all five bromophenols determined by the internal standard method using a continuous steam distillation and solvent extraction technique as described elsewhere (Chung, H. Y.; Ma, W. C. J.; Kim, J.-S., J. Agric. Food Chem. 2003, 51, 6752-6760; Chung, H. Y.; Ma, W. C. J.; Ang, P. O. Jr.; Kim, J.-S.; Chen, F., J. Agric. Food Chem. 2003, 51, 2619-2624; Whitfield, F. B.; Helidoniotis, F.; Shaw, K. J.; Svoronos, D. J. Agric. Food Chem. 1997, 45, 4398-4405; Whitfield, F. B.; Helidoniotis, F.; Shaw, K. J.; Svoronos, D. J. Agric. Food Chem. 1999, 47, 2367-2373). The result was showed in FIG. 1.

Data in FIG. 1 showed that the bromophenol content in the fish could be significantly (p<0.05) increased with the use of 30% (wt/wt) marine algae in the feed. Sensory evaluation of the cooked products showed that the fish fed with the special feed of the present invention were significantly (p<0.05) different from that fed with the original conventional dry feed containing no marine algae.

1. An additive composition of a feed for breeding an organism, comprising: at least one genus of marine algae containing an effective amount of one or more compounds selected from the group consisting of unsubstituted bromophenol and bromophenols substituted with one or more substituents.

2. The additive composition according to claim 1, wherein said substituent is halo, hydroxyl, lower alkyl, lower alkoxyl, or carboxyl.

3. The additive composition according to claim 2, wherein said substituent is bromo.

4. The additive composition according to claim 3, wherein said bromophenol is selected from the group consisting of 2-bromophenol, 4-bromophenol, 2,4-dibromophenol, 2,6-dibromophenol, and 2,4,6-tribromophenol.

5. The additive composition according to claim 2, wherein said marine algae are red algae, brown algae or green algae.

6. The additive composition according to claim 5, wherein said marine alga is selected from the group consisting of Amphiroa, Callophycus, Cheilosporum, Chondria, Corallina, Delisea, Galaxaura, Gracilaria, Haliptilon, Halymenia, Lomentaria, Plocamium, Porphyra, Pterocladiella, Solieri, Cladostephus, Colpomenia, Cystophora, Ecklonia, Endarachne, Halopteris, Homoestrichus, Hormosira, Lobophora, Padina, Phyllospora, Sargassum, Sporochnus, Caulerpa, Chlorodesmis, Cladophoropsis, Codium, Enteromorpha, Halimeda and Ulva.

7. The composition according to any of claims 6, wherein said organism is a culture animal.

8. The composition according to claim 7, wherein the organism is a domestic animal, a laboratory animal, a fish, a crustacean or a shellfish.

9. A feed for an organism, comprising an effective amount of an additive composition including at least one genus of marine algae containing one or more compounds selected from the group consisting of unsubstituted bromophenol and bromophenols substituted with one or more substituents; and a conventional feed.

10. The feed according to claim 9, wherein said substituent is halo, hydroxyl, lower alkyl, lower alkoxyl, or carboxyl.

11. The feed according to claim 10, wherein said substituent is bromo.

12. The feed according to claim 11, wherein said bromophenol is selected from the group consisting of 2-bromophenol, 4-bromophenol, 2,4-dibromophenol, 2,6-dibromophenol, and 2,4,6-tribromophenol.

13. The feed according to claims 10, wherein said marine algae are red algae, brown algae or green algae.

14. The feed according to claim 13, wherein said marine alga is selected from the group consisting of Amphiroa, Callophycus, Cheilosporum, Chondria, Corallina, Delisea, Galaxaura, Gracilaria, Haliptilon, Halymenia, Lomentaria, Plocamium, Porphyra, Pterocladiella, Solieri, Cladostephus, Colpomenia, Cystophora, Ecklonia, Endarachne, Halopteris, Homoestrichus, Hormosira, Lobophora, Padina, Phyllospora, Sargassum, Sporochnus, Caulerpa, Chlorodesmis, Cladophoropsis, Codium, Enteromorpha, Halimeda and Ulva.

15. The feed according to claim 14, wherein said organism is a culture animal.

16. The feed according to claim 15, wherein the organism is a domestic animal, a laboratory animal, a fish, a crustacean or a shellfish.

17. A method for preparing a feed of claim 9, comprising the steps of:
a) drying at least one genus of marine algae; and
b) mixing an amount of dried marine algae with a conventional feed.

18. A method for enhancing the organoleptic quality in an aquaculture animal comprising feeding the aquaculture animal a feed that comprises: an effective amount of an additive composition including at least one genus of marine algae containing one or more compounds selected from the group consisting of unsubstituted bromophenol and bromophenols substituted with one or more substituents; and a conventional feed.

19. The method of claim 18, wherein the aquaculture animal is a domestic animal, a laboratory animal, a fish, a crustacean or a shellfish.

20. The method of claim 19, wherein the marine alga is Sargassum and said bromophenol is selected from the group consisting of 2-bromophenol, 4-bromophenol, 2,4-dibromophenol, 2,6-dibromophenol, and 2,4,6-tribromophenol.
